(19) United States
(12) Patent Application Publication
(10) Pub. No.: US 2007/0190261 A1
(43) Pub. Date: Aug. 16, 2007

(54) Overspray apparatus and process

(76) Inventor: Ronald Darnell, Vancouver, WA (US)

Correspondence Address: RYLANDER & ASSOCIATES PC, 406 West 12th Street, Vancouver, WA, 98660, US

(21) Appl. No.: 11/352,505

(22) Filed: Feb. 10, 2006

(51) Int. Cl. B05D 1/02; B05C 5/00

(52) U.S. Cl. 427/424; 118/300

(57) ABSTRACT

An overspray apparatus for applying liquid coating to a continuous substrate includes a connection to a coating supply; application chamber, first substrate feeder which feeds substrate to the chamber at a downward angle, second substrate feeder which feeds substrate out of the chamber, a non-fogging spray nozzle for spraying coating, adjustably mounted in the chamber, a deflector plate spaced apart from the spray nozzle so the discharge impinges on a deflector plate, and a spray shield adjustably mounted in the application chamber to permit selective application of liquid coating on regions of the substrate. A overspray method for applying liquid coatings to a moving substrate comprises continuously moving substrate through an application chamber at a downward slope, supplying liquid coating to a non-fogging spray nozzle adjustably mounted in the chamber, impinging the nozzle discharge onto a deflector plate above the substrate to deflect spray laterally away from the deflector plate and descend within the chamber onto the substrate, and shielding selected regions of substrate for depositing liquid onto selected regions of the substrate.

### FIELD OF THE INVENTION

The present invention relates to overspray application devices and methods. More particularly, the present invention relates to apparatus and methods for applying liquid coatings to a continuous substrate.

### BACKGROUND

Rolled sheet paper and plastic products are used for many applications in industry and consumer goods, a common example being paper or plastic grocery bags. Common practice is to print logos or other information on these bags. Generally this printing is accomplished by running sheets of material stored in large rolls through machinery which prints the desired designs onto the sheets, then folds and glues the material to form bags. This process is accomplished sometimes in a single line of machines, and sometimes the printing and bag forming are accomplished in separate machine lines. Either way, an important intermediate step is to apply a non-skid “frictionizing” material to the sheet surface so that it can be effectively fed through the bag forming apparatus. The industry standard for frictionizing agent is colloidal silica. Other known manufacturing processes also involve deposition of coatings on continuous substrates. The disclosed invention may therefore be applicable in many other applications.

Preventing formation of drops on the surface of the substrate paper or plastic is important to maintaining acceptable product quality. Prior attempts to prevent drop formation and provide uniform application of coatings entailed complex and expensive means or negatively impact product quality. Prior methods of applying colloidal silica include direct applications by contact rollers or atomizing fogger systems, both of which have significant drawbacks addressed by the present invention.

Contact roller systems utilize a roller which makes direct contact with one or both surfaces of the sheet as it passes through the applicator apparatus. While one side of the applicator roller is in contact with the sheet, the backside of the roller is immersed in a liquid bath. As the roller rotates, the liquid is carried on the roller surface and applied to the sheet surface as the roller makes contact with the sheet. Ideally the rotation speed of the roller would perfectly match the linear speed of the sheet, but such precise adjustment is never realistically attainable. This mismatch results in some rubbing between the sheet and the roller surface in contact with the sheet causing the printed design to smear. All contact applicator systems have some problem with smearing.

An alternative application method in the existing art is to use a non-contact atomizer fog system. The colloidal silica mixture is dispersed through atomizing nozzles creating microscopic droplets. These atomized droplets are disbursed into a high velocity air stream in a venturi-like nozzle to create a “fog”, which is impinged onto the surface of the sheet material moving through the application chamber. The droplets of this atomizer fog system are so fine that they are not easily contained within the application chamber. Oil or silica dust is dispersed throughout the facility causing maintenance problems for machinery and potential health problems for workers. Countermeasures such as special exhaust systems or personal protective equipment must be used. The nature of existing fog systems require relatively complex and expensive controls and blower systems, and tend to consume large quantities of compressed air which is energy intensive and expensive. In addition, the atomizer nozzles are easily clogged, requiring frequent costly shutdowns to clean or replace. Atomizer-fog systems also make recovery of unused product difficult.

Thus, there is a need for a way to apply surface treatments to paper and plastic sheet products which are: (1) non-contact to prevent smearing; (2) safer and easier to maintain; (3) allow higher rates of reuse of unused coatings; (4) reduce consumption of compressed air; and, (5) are easily retrofitted into existing facilities. A number of devices have provided non-contact application, but lack the simplicity and safety of the present invention. Presently known art attempts to address this problem, but has not completely solved the problem. The following represents a list of known related art:

| Reference: | Issued to: | Date of Issue: |
|---|---|---|
| U.S. Pat. No. 2,770,210 | Miller | Nov. 13, 1956 |
| U.S. Pat. No. 4,608,942 | Hayashi | Sept. 2, 1986 |
| U.S. Pat. No. 4,839,202 | Grassel, et al. | Jun. 13, 1989 |
| U.S. Pat. No. 4,944,960 | Sundholm, et al. | Jly 31, 1990 |
| U.S. App. 2003/0032682 A1 | Jarand | (published) Feb. 13, |
| | | 2003 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 2,770,210 to Miller teaches electrostatic deposition of oils onto metal substrate using a venturi atomizer, fog chamber, and forced airflow stream parallel to the direction the substrate moves. The substrate moves vertically upwards.

U.S. Pat. No. 4,608,942 to Hayashi teaches atomizing a liquid spray stream using compressed air through a venturi nozzle, separating larger liquid particles from smaller particles using a vertical multi-layer impingement plate to create a fog, accumulating the fog particles in an accumulation chamber to further separate the particles and raise the particle concentration, and using a forced air stream to agitate the fog and deposit the fog on a vertically moving substrate.

U.S. Pat. No. 4,839,202 to Grassel, et al, is similar to Kanji. It uses compressed air to atomize oil into a fog, which is dispersed into a high speed air stream. This high speed air stream removes larger oil droplets through abrupt directional changes, and is deposited on a substrate within a fog chamber which is exhausted to maintain the proper air flow. The compressed air flow through the atomizer nozzle, and thereby the flow rate of the oil, is linked to the speed of the substrate through the fog chamber using a predetermined time delay.

U.S. Pat. No. 4,944,960 to Sundholm, et al, teaches using an atomizer nozzle dispersing slurry into a fog chamber. Higher pressure air from a blower is forced into the fog chamber to entrain the smallest suspended droplets through a control valve into an application nozzle. The application nozzle uses a high pressure, high velocity air stream to contain and entrain the fog and direct it against a moving vertical substrate. The application nozzle must be adjacent to the substrate and close enough to provide a controlled air gap which helps act as a seal as air is drawn through the gap into the suction side of the air blower.

U.S. Patent Application Serial No. 2003/0032682 A1 to Jarand teaches use of a frictionizing agent of colloidal silica combined with glycerin and other agents to ease cleanup of hardened residue. Jarand does not teach application methods.

Thus, the known art teaches using very fine droplet particles forming a fog, which are then separated by removing larger heavier drops, moved by forced air through a tortuous path (to further separate out heavier drops) and deposited with forced airflow. Use of wet processes is discouraged and taught against in the cited art. The present invention process is essentially the opposite approach to the existing art—it uses a wet overspray falling with gravity rather than the fine mists. The inventor has been able to achieve adequate quality without resorting to the complex air-driven fog systems of the existing art, and by utilizing a wet system is able to recycle or reuse a high proportion of coatings which do not adhere to the substrate.

Thus, while the foregoing body of art indicates it to be well known to have an application system using a fine particle fog and forced air flow, the art described above does not teach or suggest an overspray apparatus or method which has the following combination of desirable features: (1) non-contact; (2) utilizes commonly available components; (3) safer by producing minimal particles and dust; (4) does not damage surrounding equipment from production of particles; (5) enhances recycling and reuse of coatings; (6) easily retrofitted to existing production facilities; (7) reduces consumption of compressed air; (8) minimizes exhaust requirements; (9) easier to maintain; and (10) provides adequate quality coverage with minimum of drop formation.

### SUMMARY AND ADVANTAGES

The invention is directed to apparatus and methods for applying coatings to a continuous a substrate using an overspray system and includes a connection to a supply of liquid coating, an application chamber, a first substrate feeder connected to the application chamber which feeds substrate into the chamber at an application angle between 0 and negative 90 degrees from horizontal, a second substrate feeder connected to the application chamber which feeds substrate out of the application chamber, at least one non-fogging spray nozzle for spraying coating, adjustably mounted in the application chamber, a deflector plate spaced apart from the spray nozzles so that the discharge of the spray nozzle impinges upon a deflector plate, and, at least one spray shield adjustably mounted in the application chamber, wherein the width of the spray shield is selected to be less than the width of the substrate, so as to permit selective application of liquid coating on regions of the substrate. An overspray apparatus may incorporate positive displacement or centrifugal pumping means. An overspray apparatus may incorporate a reservoir to collect unused liquid coating for reuse. An overspray apparatus may incorporate automatic reservoir level controls. An overspray apparatus may incorporate automated control of flow and pressure utilizing selected parameters.

A method for applying a coating to a continuous substrate includes the steps of continuously moving substrate through an application chamber at a downward slope, supplying liquid coating to at least one non-fogging spray nozzle adjustably mounted within the application chamber, impinging the liquid discharged from each of the nozzles onto a deflector plate above the substrate to cause the liquid coating to deflect laterally away from the deflector plate and descend within the application chamber toward the substrate, and shielding selected regions of the continuously moving substrate to permit selective deposition of liquid onto selected regions of the substrate. A method for applying liquid coatings to a continuous substrate may include pressurizing the liquid coating using positive displacement or centrifugal pumping means. A method for applying liquid coatings to a continuous substrate may include collecting unused liquid coating in a reservoir for reuse. An overspray apparatus may incorporate automated control of flow and pressure utilizing selected parameters. A method for applying liquid coatings to a continuous substrate may include automated feedback controls to control liquid pressure and flow rates based on measurable process parameters.

The overspray application apparatus and methods of the present invention presents numerous advantages, including: (1) non-contact to avoid smearing of print; (2) utilizes commonly available components; (3) safer by producing minimal particles and dust; (4) causes no damage to surrounding equipment due to production of particles; (5) enhances recycling and reuse of unused liquid coating; (6) easily retrofitted to existing production facilities; (7) reduces consumption of compressed air; (8) minimizes exhaust requirements; (9) easier to maintain; and, (10) provides adequate quality coverage with minimum of drop formation.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an isometric view of a preferred embodiment.

FIG. 2 shows a side cut away view of a preferred embodiment.

FIG. 3 shows a schematic diagram of the plumbing of a preferred embodiment.

FIG. 4 shows a schematic diagram for the controls of a preferred embodiment.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

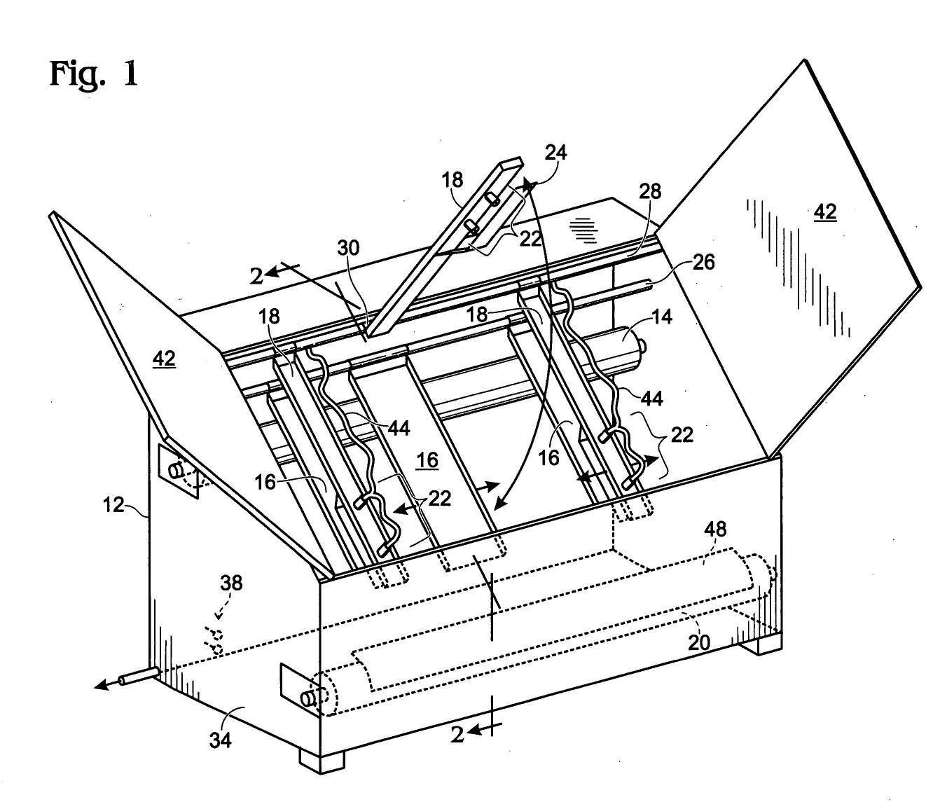

Referring to FIGS. 1-4 an overspray apparatus for applying liquid coating to a continuous substrate is shown which includes a connection to a supply of liquid coating (not shown) via flexible tubing 44, an application chamber 12, a first substrate feeder 14 connected to application chamber 12 which feeds substrate 10 into application chamber 12 at an application angle between 0 and negative 90 degrees from horizontal, a second substrate feeder 20 connected to application chamber 12 which feeds substrate 10 out of application chamber 12, at least one non-fogging spray nozzle 22 for spraying coating, adjustably mounted in application chamber 12, a deflector plate 24 spaced apart from spray nozzles 22 so that the discharge of spray nozzles 22 impinges upon deflector plate 24, one or more spray shields 16 are adjustably mounted in application chamber 12, wherein the width of spray shields 16 are selected to be less than the width of substrate 10, so as to permit selective application of liquid coating on regions of substrate 10. Substrate 10 may be continuous rolls of product, or stacked sheets which are fed continuously into application chamber 12—either could provide a continuous substrate supply.

Again referring to FIGS. 1-4, a method of applying liquid coating to a continuous substrate includes the steps of continuously moving substrate 10 through application chamber 12 at a downward slope, supplying liquid coating to at least one non-fogging spray nozzle 22 adjustably mounted within application chamber 12, impinging the liquid discharged from spray nozzles 22 onto deflector plates 24 above substrate 10 to cause the liquid coating to deflect laterally away from deflector plates 24 and descend within application chamber 12 toward substrate 10, and shielding selected regions of the continuously moving substrate 10 using spray shields 16 to permit selective deposition of liquid onto selected regions of the substrate 10.

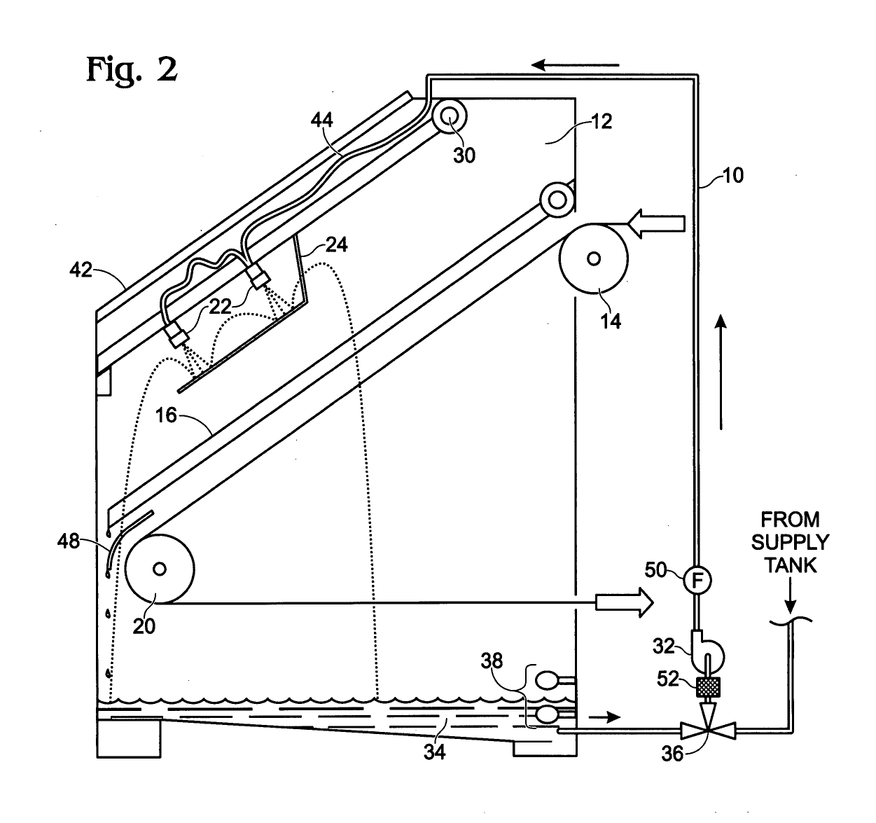

Referring to FIGS. 1, 2 & 3 an embodiment of the invention is shown. This embodiment is for applying colloidal silica to the printed surface of a substrate such as paper or plastic sheet used for manufacturing bags. Substrate 10 is fed into application chamber 12 via feed roller 14. Substrate 10 travels at a downward angle below spray shields 16. The angle can range between horizontal and vertical, preferably negative 35 degrees plus or minus approximately 10 degrees from horizontal, in order to prevent drops from accumulating on the substrate surface. Other angles between horizontal and vertical may be required due to space and layout restrictions, and the angle may be varied as necessary without departing from this invention even though less optimum. Coatings with viscosity greater or less than typical colloidal silica mixtures may also require greater or lesser optimum angles as well. These variations are easily apparent to persons of ordinary skill in the art. Feed roller 14 may be part of a group of rollers positioned to receive the substrate from an external source not shown. Such an external source might be located above or below the overspray apparatus, as well as either in front of or behind it, so that several roller devices might be needed to redirect the substrate into the overspray apparatus, and could be repositioned on the overspray apparatus depending on the required layout. A single roller 14 is shown here for simplicity.

Spray nozzles 22 are adjustably mounted over spray shields 16 such that spray shields 16 prevent deposition on the selected regions of substrate passing underneath spray shields 16. Spray shields 16 extend the entire distance between feed roller 14 and exit roller 20. Spray nozzles 22 may be mounted in spray bars 18 for easy access and adjustment. Spray nozzles 22 are commercially available non-fogging high-pressure nozzles. This embodiment utilizes nozzles with a fan-shaped discharge pattern, aligned with the long axis parallel to the direction of substrate travel, but any pattern may be used which gives satisfactory deflection spray coverage. In this embodiment the spray nozzles 22 are mounted over the lower half of the substrate exposed between feed roller 14 and exit roller 20. Placing spray nozzles 22 low in application chamber 12 allows excess silica mixture to run off immediately when substrate 10 bends around exit roller 20 and then faces downward, thereby preventing runs on substrate 10.

Exit roller 20 may be part of a group of rollers positioned to direct the substrate to an external receiver not shown. Such an external receiver might be located above or below the overspray apparatus, as well as either in front of or behind it, so that several roller devices might be needed to redirect the substrate from the overspray apparatus to the receiver, and could be repositioned on the overspray apparatus depending on the required layout. A single roller 20 is shown here for simplicity. Exit roller 20 performs several functions. First, its position sets the downward angle of the substrate traveling through the deposition zone. Second, it maintains proper tension on the substrate to prevent sagging or excessive undulation. Third, it imposes a direction change on the substrate—from a downward slope in one direction to a downward or horizontal slope in the opposite direction—which assists in flinging off excess coating material. Finally, exit roller 20 aligns the substrate to feed into the next step of the process, whether to another manufacturing step or to a storage roller.

Deflector plates 24 are located below spray nozzles 22, spaced approximately three inches from the nozzle discharge. Deflector plates 24 are slightly wider than the width of the spray pattern from nozzles 22 at this distance, so that all discharge from nozzles 22 is deflected to form a heavy spray effect within application chamber 12. It is important to avoid formation of fog from nozzles 22 or the deflected spray pattern as this would allow silica to drift freely within the application chamber and deposit anywhere on substrate 10, rather than being shielded by spray shields 16. Maintaining a wet spray pattern rather than a fine particulate fog allows the deposition pattern to be controlled by gravity and shielding, eliminating the need for forced air streams to direct the silica flow. This simplicity permits substantial cost reductions in both fabrication and maintenance of the apparatus. Although a single deflector plate 24 is shown for each pair of spray nozzles 22 per spray bar 18, each nozzle 22 could be provided with an individual deflector plate 24. More or fewer nozzles 22 could be used depending on desired coverage and the dimensions of substrate 10.

Spray shields 16 should be spaced as close as practicable to substrate 10 in order to provide more precise control over the deposition process, but should not permit contact between substrate 10 and spray shields 16, even accounting for the slight undulation of substrate 10 while moving at high speeds between feed roller 14 and exit roller 20. In this embodiment spray shields 16a-c are mounted slidably on rails 26 for easy adjustment of lateral position, but spray shields may be mounted in any convenient manner which allows adjustment to create differing coverage zones. For example, rails 26 may be provided with spaced bolt holes or dowels, or spray shields 16 could be fixed to rails 26 with rails 26 able to move laterally. Mounting spray shields 16 slidably on rails 26 also allows for easy removal for cleaning and maintenance. Spray bars 18 are also mounted on rails 28 to permit lateral adjustment, but alternative arrangements are likewise available which permit both lateral adjustment and ease of maintenance. Spray bars 18 are also provided with hinges to permit easy access to spray shields 16 for cleaning and for replacement of nozzles. Nozzles 22 are connected by any compatible method.

Pump 32 supplies pressure and flow to-nozzles 22. In this embodiment pump 32 is an air operated double-diaphragm pump commonly used for industrial applications. Diaphragm pumps as used in this embodiment have certain advantages: they are inexpensive, durable, easily maintained and replaced, discharge pressure is easily controlled by controlling the air supply pressure, and flow rate is easily controlled by controlling the air supply flow rate. Other commonly used industrial pumps such as centrifugal pumps, bellows pumps, peristaltic pumps, or rotary positive displacement pumps could also be used. Strainer 52 is a typical addition well known in the art to protect pump 32 from contaminants. Filter 50 is installed to prevent fouling of nozzles 22 and prevent small contaminants which could affect quality of the coatings. Many such filters are known to those of skill in the art, but preferably a filter rating of approximately 100 microns should be used for colloidal silica applications.

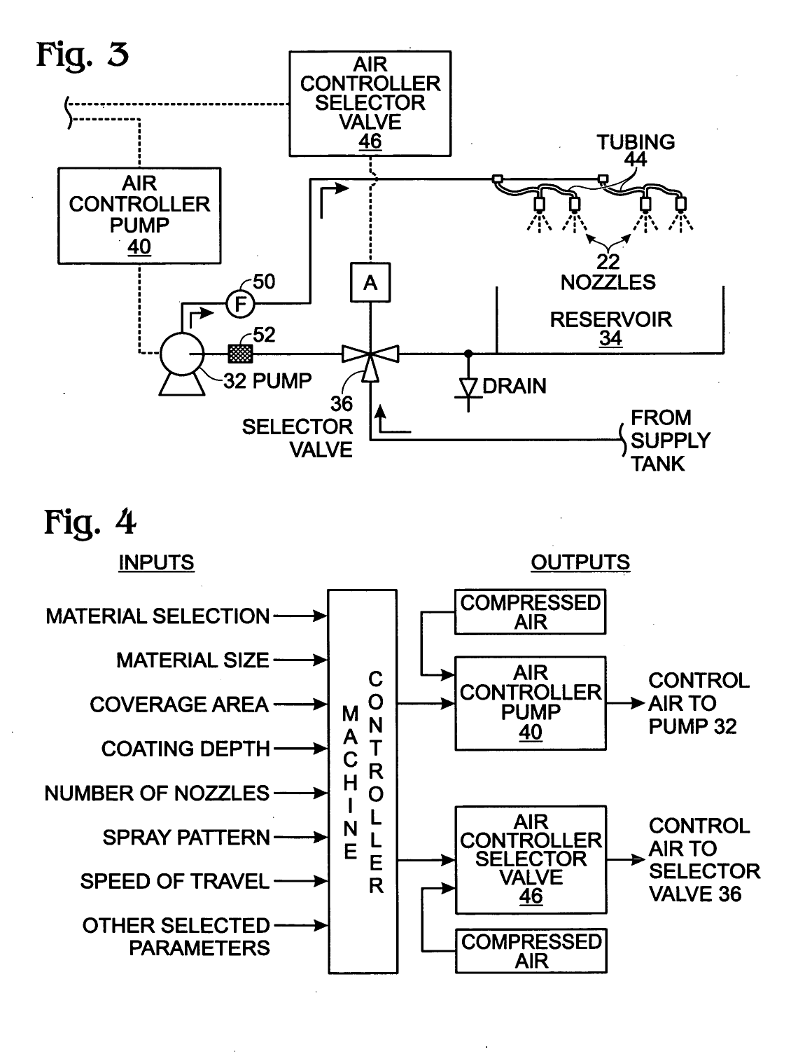

Referring to FIGS. 3 & 4 with FIGS. 1 & 2, a simple control scheme for a preferred embodiment is shown. Simple automated controls allow variation of pressure and flow rate to nozzles 22 based upon selectable parameters such as: the material of the substrate; the width of the substrate; the magnitude of the desired area of coating of the substrate; the depth of coating desired; the number of spray nozzles installed; the spray nozzle pattern; the speed travel of the substrate 10 through application chamber 12; and, the level of liquid in reservoir 34. Other parameters could also be used. Automated control can be accomplished by using a commercially available air controller 40 to control the air supply to pump 32, with the electrical control signal to air controller 40 supplied by a manual 0-10vdc rheostat, or alternatively by a computer controlling the machinery.

Selector valve 36 aligns the suction of pump 32 to a supply tank (not shown) or to collection reservoir 34 in the lower part of application chamber 12. Air or solenoid operation permits automatic realignment when the level of reservoir 34 gets low as indicated by float switches 38, for example by using a commercially available air controller or solenoid valve 46. Alternative arrangements for selector valve 36 could comprise using standard two-way valves in combination or using a mixing valve. Another alternative could include using a float switch operating a pilot valve in line with the control air to selector valve 36, or a float switch operating electrical contacts in line with a solenoid controlling the position of selector valve 36. Valves could be manually operated, pneumatically operated, solenoid operated, motor operated, or use any other operator compatible with the process. Other methods well known to persons of ordinary skill in the art for detecting the liquid level in reservoir 34 could be used as well, such as optical detectors, magnetic floats, radar systems, sonar systems, ultrasonic systems, submerged antennae systems, electrical conductance systems, capacitance or inductance sensors, or load cell systems.

The discharge of pump 32 is directed to nozzles 22 via flexible polyurethane tubing 44 with standard connection methods well known in the art; however, any piping could be used which is chemically compatible and has compatible connections. Flexible tubing 44 provides certain advantages such as ease of replacement and permitting spray bars 22 to be movable for maintenance access.

An alternative arrangement for pump 32 could include separate pumps dedicated for supplying new coating from a separate supply source and supplying recycled coating from reservoir 34. Separate pumps could include valving for connecting each dedicated pump to its respective supply and to connect each dedicated pump to spray nozzles 22. Discharge from each separate dedicated pump could be piped to dedicated spray nozzles, or to all spray nozzles. Discharge from separate dedicated pumps could be exclusive, such that only one source of coating is used at a time, or could be mixed between multiple sources including new coating supply and reservoir 34. Automated controls such as used to control selector valve 36 could easily be modified to control separate dedicated pumps. Such modification is within the knowledge of a person of ordinary skill in the art.

Feed roller 14 and exit roller 20 may be standard rollers known in the art. The rollers are adjustable to ensure true alignment and proper tensioning. The position of the rollers 14 and 20 may be changed depending on the layout of the overspray apparatus in relation to other machinery. Exit roller shield 48 protects exit roller 20. Covers 42 simply seal the application chamber 12. Any arrangement of covers or doors providing containment may be used.

In the described embodiment the wetted surfaces of the apparatus are constructed primarily from stainless steel for durability and anti-corrosion properties over a wide pH range, but any chemically compatible material may be used, including non-stainless steel with chemically compatible coatings, various plastics, and other materials.

In operation of the described embodiment, substrate 10 is fed into application chamber 12 via feed roller 14. Feed roller 14 directs substrate 10 into the deposition region. Substrate 10 travels at a downward angle, preferably 35 degrees, plus or minus 10 degrees, although any angle between horizontal and vertically downward could be used if other constraints require. Substrate 10 passes under spray shields 16, which are positioned to allow coverage only on selected regions of substrate 10.

Spray nozzles 22, installed in spray bars 18, direct discharge to impinge on deflector plates 24. Spray nozzles 22 in this embodiment are located in the lower half of the deposition region. This position minimizes potential formation of drops due to excess coating running down the surface of substrate 10. In this embodiment spray nozzles 22 are standard high pressure, non-fogging nozzles with a fan-shaped spray pattern. The long axis of the spray pattern is aligned parallel to the direction of travel of substrate 10 through the deposition region to provide even coverage. Other spray nozzle patterns may be used depending on the coating used, the type of substrate material, speed of travel, or other relevant parameters. Deflector plates 24 are spaced approximately 1 to 12 inches (25 millimeters to 300 millimeters), preferably approximately 3 inches (76 millimeters), from spray nozzles 22 in this embodiment, which provides optimum overspray coverage for colloidal silica on paper. This spacing would vary depending on the particular nozzles, pressures and flow rates used in a specific process. Deflector plates 24 are slightly wider than the spray pattern impinging on it at this distance to ensure that substantially all liquid is deflected laterally to produce sufficient overspray coverage, as well as reducing the velocity of droplets to prevent damage to substrate 10. Those skilled in the art will know that spacing can be varied to ensure desired coverage, as determined by observing overspray coverage under intended production conditions and adjusting for optimum results.

Substrate 10 exits the containment chamber after an abrupt change of direction imparted by exit roller 20. Exit roller 20 directs substrate 10 from downward angle in one direction to a horizontal or downward angle in the opposite direction. This abrupt directional change assists in flinging off excess coating, thereby preventing formation of drops. Exit roller 20 also aligns substrate 10 to feed into the next process step, whether another manufacturing step or a storage roller. Exit roller 20 can be part of a series of rollers to align with other processes, as described above.

Excess coating can be collected in a reservoir 34 for reuse or disposal. Reservoir 34 is plumbed to pump 32 through selector valve 36, so that the operator may select between the reservoir 34, a separate supply tank (not shown), or a mix of the two. Float switches 38 may be integrated with pumping controls to automatically switch pump 32 to a separate supply tank when reservoir 34 is low, or to mix the sources. Pump 32 supplies pressure and flow to nozzles 22 via flexible tubing 44. Covers 42 provide access to the application chamber during maintenance and provide containment during operation.

Referring to FIGS. 1-4 an overspray method for coating a continuous substrate is shown. Substrate 10 is continuously fed into application chamber 12 at a downward slope, preferably at a downward angle between 25 degrees and 45 degrees from horizontal in applying colloidal silica to paper and plastic bag materials. Other coating-substrate combinations might require different angles depending on the viscosity of the coating and speed of the substrate. Pump 32 supplies coating to non-fogging nozzles 22. Pump 32 can be supplied with coating from a supply tank (not shown) or can reuse coating by drawing from reservoir 34, through selector valve 36. Float switches 38 may be integrated with pumping controls to automatically switch pump 32 to a separate supply tank when reservoir 34 is low, or to mix the sources. Other methods well known to persons of ordinary skill in the art for detecting the liquid level in reservoir 34 could be used as well, such as optical detectors, magnetic floats, radar systems, sonar systems, ultrasonic systems, submerged antennae systems, electrical conductance systems, capacitance or inductance sensors, or load cell systems.

In this embodiment pump 32 is an air operated double-diaphragm pump commonly used for industrial applications. Diaphragm pumps as used in this embodiment have certain advantages: they are inexpensive, durable, easily maintained and replaced, discharge pressure is easily controlled by controlling the air supply pressure, and flow rate is easily controlled by controlling the air supply flow rate. Other commonly used industrial pumps such as centrifugal pumps, bellows pumps, peristaltic pumps, or rotary positive displacement pumps could also be used. Selector valve 36 could be a single selector valve, or a group of valves operated together to align the suction and discharge of pump 32. Valves could be manually operated, pneumatically operated, solenoid operated, motor operated, or use any other compatible operator. Another alternative could include using a float switch operating a pilot valve in line with the control air to selector valve 36, or a float switch operating electrical contacts in line with a solenoid controlling the position of selector valve 36.

The coating discharged through nozzles 22 impinges on deflector plates 24 thereby deflecting the spray laterally. The deflected spray is wet rather than a fine mist fog, so that the deflected spray descends onto substrate 10. Spray shields 16 prevent coating from contacting selected regions of substrate 10 so that only the overspray is deposited on substrate 10. Coating falling on spray shields 16 drains down to bottom end of spray shield 16 and is collected in reservoir 34. Spray shields 16 are mounted at the same 25 to 45 degree slope as substrate 10, which causes drops forming on the edge of spray shields 16 to travel all the way to the bottom and drain into reservoir 34, rather than falling onto substrate 10. Preventing fog from the nozzles allows control over the deposition by positioning spray shields 16. Pump 32 and selector valve 36 may be controlled automatically by integrating electric or pneumatic controls with the machine, as described for the apparatus above. Strainer 52 is a typical addition well known in the art to protect pump 32 from contaminants. Filter 50 is installed to prevent fouling of nozzles 22 and prevent small contaminants 1o which could affect quality of the coatings. Many such filters are known to those of skill in the art, but preferably a filter rating of approximately 100 microns should be used for colloidal silica applications.

An alternative arrangement for pump 32 could include separate pumps dedicated for supplying new coating from a separate supply source and supplying recycled coating from reservoir 34. Separate pumps could include valving for connecting each dedicated pump to its respective supply and to connect each dedicated pump to spray nozzles 22. Discharge from each separate dedicated pump could be piped to dedicated spray nozzles, or to all spray nozzles. Discharge from separate dedicated pumps could be exclusive, such that only one source of coating is used at a time, or could be mixed between multiple sources including new coating supply and reservoir 34. Automated controls such as used to control selector valve 36 could easily be modified to control separate dedicated pumps. Such modification is within the knowledge of a person of ordinary skill in the art.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. An apparatus for applying liquid coating to a continuous substrate, comprising:
a connection to a supply of liquid coating;
an application chamber;
a first substrate feeder connected to said application chamber which feeds substrate into said chamber at an application angle between 0 and negative 90 degrees from horizontal;
a second substrate feeder connected to said application chamber which feeds substrate out of said application chamber;
at least one non-fogging spray nozzle for spraying coating, in fluid communication with said liquid coating supply connection, adjustably mounted in the application chamber;
a deflector plate spaced apart from said spray nozzle so that the discharge of the spray nozzle impinges upon a deflector plate; and,
at least one spray shield adjustably mounted in the application chamber, wherein the width of said at least one spray shield is selected to be less than the width of said substrate, so as to permit selective application of liquid coating on regions of said substrate.

2. The apparatus of claim 1, further comprising pumping means in fluid communication with said liquid coating supply connection and said at least one spray nozzle for supplying liquid coating to said at least one spray nozzle.

3. The apparatus of claims 1 or 2, further comprising a reservoir in fluid communication with said application chamber for collecting unused liquid coating.

4. The apparatus of claim 3, further comprising a liquid level detector connected to said reservoir.

5. The apparatus of claims 3 or 4, wherein said pumping means further comprises valve means in fluid communication with said pumping means, said reservoir, and said liquid coating supply connection for selecting the pumping means supply source to said supply of liquid coating or said reservoir.

6. The apparatus of claim 5, wherein said valve means is able to select between either said supply source or said reservoir, or a mixture of said supply source and said reservoir.

7. The apparatus of claims 5 or 6, wherein said valve means source selection is automatically controlled based on the level of liquid in the reservoir.

8. The apparatus of claim 2, further comprising an automatic pump discharge pressure and flow control set to automatically control pumping means pressure and flow using at least one of the following parameters:
the material of the substrate;
the width of the substrate;
the magnitude of the desired area of coating of the substrate;
the depth of coating desired;
the number of spray nozzles installed;
the spray nozzle pattern;
the speed of travel of the substrate; and
the level of liquid in the reservoir.

9. The apparatus of claim 1, wherein the angle of travel of the substrate through the application chamber is in the range of negative 25 degrees to negative 45 degrees from horizontal.

10. The apparatus of claim 1, further comprising at least one spray bar movably mounted in said application chamber having at least one spray nozzle mounted each such spray bar.

11. The apparatus of claim 1, wherein the deflector plate is spaced apart from the spray nozzle in the range of 1 inch to 12 inches (25 millimeters to 300 millimeters).

12. The apparatus of claim 1, wherein said first substrate feeder comprises at least one roller which can be re-positioned to accommodate differing directions of supply feed systems.

13. The apparatus of claim 1, wherein said second substrate feeder comprises at least one roller which can be repositioned to accommodate differing directions of outlet feed systems.

14. The apparatus of claim 1, wherein at least one said spray nozzle provides an elongated fan-shaped discharge pattern aligned on its long axis in the direction of travel of the substrate, and further wherein said deflector plate width is greater than the width of said spray nozzle discharge at the point of impingement.

15. The apparatus of claim 2, wherein the pumping means comprises at least one air operated positive displacement pump.

16. An apparatus for applying frictionizing coating to paper and plastic substrate, comprising:
a connection to a supply of frictionizing coating;
an application chamber;
a first substrate feeder means connected to said application chamber to accept a continuous feed of substrate from an external source and guide the substrate to the application chamber at a downward angle;
a second substrate feeder means connected to said application chamber to accept a continuous feed of substrate from the application chamber at a downward angle and guide the substrate to an external receiver at an exit angle which is greater than or equal to 180 degrees when measured from vertical up;
at least one non-fogging spray nozzle for spraying frictionizing coating in fluid communication with said frictionizing coating supply connection;
a deflector plate spaced apart from said at least one spray nozzle so that the discharge of the spray nozzle impinges upon a deflector plate;
at least one spray shield movably mounted at a selected position to allow selective application of frictionizing coating onto at least selected region of the substrate;

17. The apparatus of claim 16, further comprising pumping means in fluid communication with said frictionizing coating supply connection and said at least one spray nozzle, for supplying liquid coating to said at least one spray nozzle.

18. The apparatus of claims 16 or 17, further comprising a reservoir in fluid communication with said application chamber to collect unused or excess frictionizing coating;

19. The apparatus of claim 17, wherein said pumping means further comprises valve means in fluid communication with said pumping means suction, said supply of liquid coating, and said reservoir, for selecting the pumping means supply source between said supply of frictionizing coating or said reservoir, or a mixture of said supply and said reservoir.

20. The apparatus of claim 16 further comprising an automatic pump discharge pressure and flow control set to automatically control pumping means pressure and flow using at least one of the following parameters:
the material of the substrate;
the width of the substrate; the magnitude of the desired area of coating of the substrate;
the depth of coating desired;
the number of spray nozzles installed;
the spray nozzle pattern;
the speed of travel of the substrate; and, the level of liquid in the reservoir.

21. A method for applying liquid coatings to a moving substrate, comprising the steps of:
continuously moving substrate through an application chamber at a downward slope;
supplying liquid coating to at least one non-fogging spray nozzle adjustably mounted within said application chamber;
impinging the liquid discharged from each of said at least one nozzles onto a deflector plate above the substrate to cause said liquid coating to deflect laterally away from the deflector plate and descend within said application chamber toward said substrate; and,
shielding selected regions of the continuously moving substrate to permit selective deposition of liquid onto selected regions of the substrate.

22. The method of claim 21 further comprising the step of pressurizing said supply of liquid coating using pumping means in fluid communication with said supply of liquid coating and said at least one spray nozzle.

23. The method of claims 21 or 22 further comprising the step of continuously collecting excess liquid in a reservoir in fluid communication with said application chamber for reuse in the process.

24. The method of claim 23 further comprising the step of providing means to select between said supply of liquid coating and said reservoir as a supply for said pumping means.

25. The method of claim 24 wherein the step of providing means to select between said supply of liquid coating and said reservoir further comprises selecting a mix of said liquid coating supply and said reservoir at an adjustable ratio.

26. The method of claim 22 wherein the step of pressurizing with said pumping means is controlled automatically based on a set of parameters comprising at least one of the following:
the material of the substrate;
the width of the substrate;
the magnitude of the desired area of coating of the substrate;
the depth of coating desired;
the number of spray nozzles installed;
the spray nozzle pattern;
the speed of travel of the substrate; and,
the level of liquid in the reservoir.

27. An overspray apparatus for applying liquid coatings to a moving substrate, comprising:
means for continuously moving substrate through an application chamber at a downward slope;
means for supplying liquid coating;
spray means in fluid communication with said supplying means for providing a non-fogging spray of liquid coating within said application chamber;
deflecting means for deflecting spray from said spray means laterally and descendingly within said application chamber onto said substrate;
shielding means for shielding selected regions of said substrate to permit selective deposition of liquid coating onto selected regions of said substrate.

28. The apparatus of claim 27 wherein the means for supplying liquid coating further comprises pumping means in fluid communication with said supplying means and said spray means for pressurizing said supply of liquid coating.

29. The apparatus of claims 27 or 28 further comprising collecting means in fluid communication with said application chamber to continuously collect excess liquid for reuse in the process.

30. The apparatus of claim 29 further comprising the selecting means to select between said supplying means and said collecting means as a supply for said pumping means.

31. The apparatus of claim 30 wherein said selecting means further allows selecting a mix of said supplying means and said collecting means at an adjustable ratio.

32. The apparatus of claim 28 further comprising automatic control means wherein said pumping means is controlled automatically based on a set of parameters comprising at least one of the following:
the material of the substrate;
the width of the substrate;
the magnitude of the desired area of coating of the substrate;
the depth of coating desired;
the number of spray nozzles installed;
the spray nozzle pattern;
the speed of travel of the substrate; and,
the level of liquid in the reservoir.
